(19) United States
(12) Patent Application Publication
(10) Pub. No.: US 2024/0187272 A1
(43) Pub. Date: Jun. 6, 2024

(54) TERMINAL AND RADIO COMMUNICATION METHOD

(71) Applicant: NTT DOCOMO, INC., Tokyo (JP)

(72) Inventors: Shohei Yoshioka, Tokyo (JP); Yuki Matsumura, Tokyo (JP); Satoshi Nagata, Tokyo (JP)

(73) Assignee: NTT DOCOMO, INC., Tokyo (JP)

(21) Appl. No.: 18/282,148

(22) PCT Filed: Mar. 16, 2021
(86) PCT No.: PCT/JP2021/010580

§ 371 Date: Sep. 14, 2023

(51) Int. Cl. H04L 12/18; H04L 1/1812

(52) U.S. Cl. CPC H04L 12/1868; H04L 1/1819

(57) ABSTRACT

A terminal receives a downlink data channel common to a group of terminals in data distribution for multiple terminals. The terminal assumes that a process number of an automatic retransmission request in the downlink data channel is different from a process number of an automatic retransmission request in a terminal-specific downlink channel.

### TECHNICAL FIELD

This disclosure relates to a terminal and a radio communication method supporting a multicast/broadcast service.

### BACKGROUND ART

3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

Release 17 of 3GPP covers simultaneous data transmission (also called broadcasting) services (tentatively called MBS) to multiple specified or unspecified terminals (User Equipment, UE) in NR (Non-Patent Literature 1).

In MBS, for example, the scheduling of UE groups to be serviced and the improvement of reliability (For example, feedback to a HARQ (Hybrid Automatic repeat request) radio base station (gNB)) are being studied.

### CITATION LIST

### Non-Patent Literature

Non-Patent Literature 1: “New Work Item on NR support of Multicast and Broadcast Services,” RP-193248, 3GPP TSG RAN Meeting #86, 3GPP, December 2019

### SUMMARY OF INVENTION

In an MBS, data transmitted to multiple UEs (transport blocks (TBs)) can be retransmitted to a specific UE, that is, by unicasting.

In this case, the UE may not be able to properly receive the data to be retransmitted due to multiple methods and handling of the HARQ (Automatic Retransmission Request) process.

Therefore, the following disclosure has been made in view of this situation and aims to provide a terminal and radio communication method that can more reliably receive the data to be retransmitted in a simultaneous data transmission service to multiple specified or unspecified terminals.

One aspect of the disclosure is a terminal (UE200) including a reception unit (radio signal transmission and reception unit 210) that receives a downlink data channel common to a group of terminals in data distribution for multiple terminals and a control unit (control unit 270) that assumes that a process number of an automatic retransmission request in the downlink data channel is different from a process number of an automatic retransmission request in a terminal-specific downlink channel.

One aspect of the disclosure is a terminal (UE200) including a reception unit (radio signal transmission and reception unit 210) that receives a downlink data channel common to a group of terminals in data distribution for multiple terminals and a control unit (control unit 270) that assumes that specific identification information for retransmission is used for scrambling a downlink control channel and a terminal-specific downlink channel when the downlink data channel is retransmitted to a specific terminal.

One aspect of the disclosure is a terminal (UE200) including a reception unit (radio signal transmission and reception unit 210) that receives a downlink data channel common to a group of terminals in data distribution for multiple terminals and a control unit (control unit 270) that assumes that a block transmitted via the downlink data channel is retransmitted to only one of the terminals or a specific terminal.

One aspect of the disclosure is a terminal (UE200) including a reception unit that (radio signal transmission and reception unit 210) receives a downlink data channel common to a group of terminals in data distribution for multiple terminals and a control unit (control unit 270) that assumes that a block transmitted via the downlink data channel can be retransmitted to both the terminals and a specific terminal.

One aspect of the disclosure is a radio communication method including the steps of receiving a downlink data channel common to a group of terminals in data distribution for multiple terminals and assuming that a process number of an automatic retransmission request in the downlink data channel is different from a process number of an automatic retransmission request in a terminal-specific downlink channel.

One aspect of the disclosure is a radio communication method including the steps of receiving a downlink data channel common to a group of terminals in data distribution for multiple terminals and assuming that specific identification information for retransmission is used for scrambling a downlink control channel and a terminal-specific downlink channel when the downlink data channel is retransmitted to a specific terminal.

### BRIEF DESCRIPTION OF DRAWINGS

FIG. 1 is an overall schematic diagram of a radio communication system 10.

FIG. 2 is a diagram showing an example configuration of the radio frame, subframe and slot used in radio communication system 10.

FIG. 3 shows configuration examples of PTM transmission method 1 and PTM transmission method 2.

FIG. 4 is a functional block diagram of gNB100 and UE200.

FIG. 5 is a diagram showing a sequence example of PDSCH and HARQ feedback in operation example 1.

FIG. 6 is a diagram showing a sequence example of PDCCH, PDSCH and HARQ feedback in Operation Example 2.

FIG. 7 is a diagram showing a sequence example of PDSCH and HARQ feedback in operation example 3.

FIG. 8 shows an example of the hardware configuration of the gNB100 and the UE200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

### (1.1) Example System Configuration

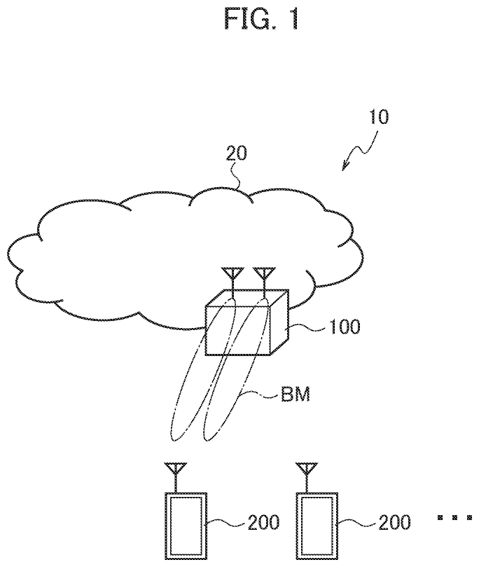

FIG. 1 is an overall schematic diagram of a radio communication system 10 according to the present embodiment. radio communication system 10 is a radio communication system according to 5G New Radio (NR) and includes a Next Generation-Radio Access Network 20 (NG-RAN 20, and several terminals 200 (User Equipment 200, below, UE200).

The radio communication system 10 may be a radio communication system according to a scheme called Beyond 5G, 5G Evolution or 6G.

The NG-RAN20 includes a radio base station 100 (Below: gNB100). The specific configuration of radio communication system 10 including the number of gNBs and UEs is not limited to the example shown in FIG. 1.

The NG-RAN20 actually includes multiple NG-RAN nodes, specifically, gNBs (or ng-eNBs), and is connected to a core network (5 GC, not shown) according to 5G. Note that the NG-RAN20 and 5 GCs may simply be described as a network.

The gNB100 is a radio base station in accordance with NR and performs radio communication in accordance with the UE200 and NR. By controlling radio signals transmitted from multiple antenna elements, the gNB100 and UE200 are capable of supporting Massive MIMO, which generates a more directional beam BM, carrier aggregation (CA), which uses multiple component carriers (CCs) bundled together, and dual connectivity (DC), which simultaneously communicates between the UE and each of the multiple NG-RAN nodes.

The radio communication system 10 corresponds to FR1 and FR2. The frequency bands of each FR (Frequency Range) are as follows:
FR1:410 MHz to 7.125 GHz
FR2:24.25 GHz to 52.6 GHz FR1 uses sub-carrier spacing (SCS) of 15, 30 or 60 kHz and may use a bandwidth (BW) of 5˜100 MHz. FR2 is a higher frequency than FR1, uses SCS of 60 or 120 kHz (240 kHz may be included) and may use a bandwidth (BW) of 50˜400 MHz.

In addition, radio communication system 10 may support a higher frequency band than that of FR2. Specifically, radio communication system 10 may support frequency bands above 52.6 GHz and up to 114.25 GHz. radio communication system 10 may also support frequency bands between FR1 and FR2.

Cyclic Prefix-Orthologous Frequency Division Multiplexing (CP-OFDM)/Discrete Fourier Transform-Spread (DFT-S-OFDM) with larger Sub-Carrier Spacing (SCS) may also be applied. Furthermore, DFT-S-OFDM may be applied to the downlink (DL) as well as the uplink (UL).

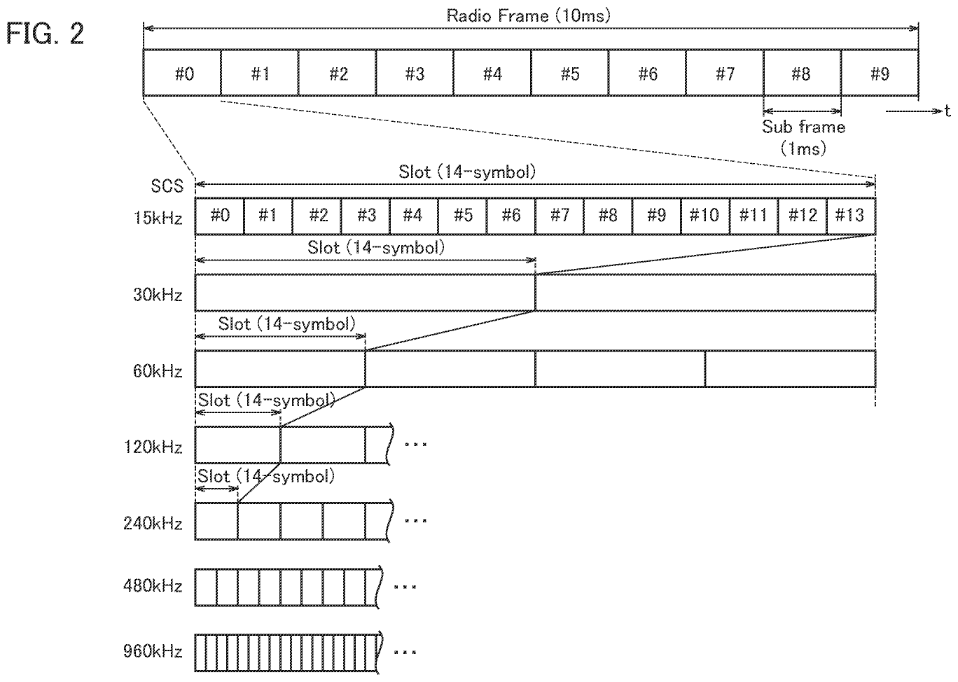

FIG. 2 shows an example configuration of the radio frame, subframe and slot used in radio communication system 10.

As shown in FIG. 2, one slot consists of 14 symbols, and the larger (wider) the SCS, the shorter the symbol period (and slot period). The number of symbols constituting one slot need not necessarily be 14 symbols (For example, 28, 56 symbols). In addition, the number of slots per subframe may vary depending on the SCS. In addition, the SCS may be wider than 240 kHz (For example, as shown in FIG. 2, 480 kHz, 960 kHz).

Note that the time direction (t) shown in FIG. 2 may be referred to as a time domain, symbol period or symbol time. The frequency direction may also be referred to as a frequency domain, resource block, resource block group, subcarrier, BWP (bandwidth part), subchannel or common frequency resource.

### (1.2) Providing MBS

In the radio communication system 10, multicast and broadcast services (MBS) may be provided.

For example, in a stadium or hall, many UE200s may be located within a certain geographic area, and many UE200s may receive the same data simultaneously. In such a case, the use of MBS rather than Unicast is effective.

Unicast may be interpreted as communication that takes place one-to-one with the network by specifying one specific UE200 (identification information specific to the UE200 may be specified).

Multicasting may be interpreted as communication that takes place one-to-many (specific many) with the network by specifying multiple specific UEs 200 (identification information for multicasting may be specified). It should be noted that as a result, the number of UEs 200 that receive data for receiving multicasting may be 1.

Broadcast may be interpreted as communication between the network and an unspecified number of UEs 200. The data to be multicasted/broadcast may have identical copied content, but some content such as headers may be different. Also, while the data to be multicasted/broadcast may be transmitted (distributed) at the same time, it does not necessarily require strict concurrency and may include propagation delays and/or processing delays within PAN nodes, etc.

Note that the target UE200 may be in the radio resource control layer (RRC) state of either idle (RRC idle), connected (RRC connected) or other state (For example, an inactive state). The inactive state may be interpreted as a state in which some configurations of the RRC are maintained.

MBS envisions three methods for scheduling the multicast/broadcast Physical Downlink Shared Channel (PDSCH), specifically scheduling MBS packets (which may be read as data):. RRC connected UE may be read as RRC idle UE and RRC inactive UE.
PTM transmission method 1 (PTM-1): —Schedule group-common PDSCH using group-common PDCCH (Physical Downlink Control Channel) for MBS group of RRC connected UE.
CRC(Cyclic Redundancy Checksum) and PDSCH of PDCCH are scrambled by group-common RNTI (Radio Network Temporary Identifier, may be called G-RNTI).
PTM Transmission Method 2 (PTM-2):—For the MBS group of the RRC connected UE, the group-common PDSCH is scheduled using the terminal-specific (UE-specific) PDCCH.
The CRC of the PDCCH is scrambled by the UE-specific RNTI.
The PDSCH is scrambled by the group-common RNTI.
PTP transmission method: —UE-specific PDSCH is scheduled for the RRC connected UE using UE-specific PDCCH.
CRC and PDSCH of PDCCH are scrambled by UE-specific RNTI. This may mean that MBS packets are transmitted by Unicast.

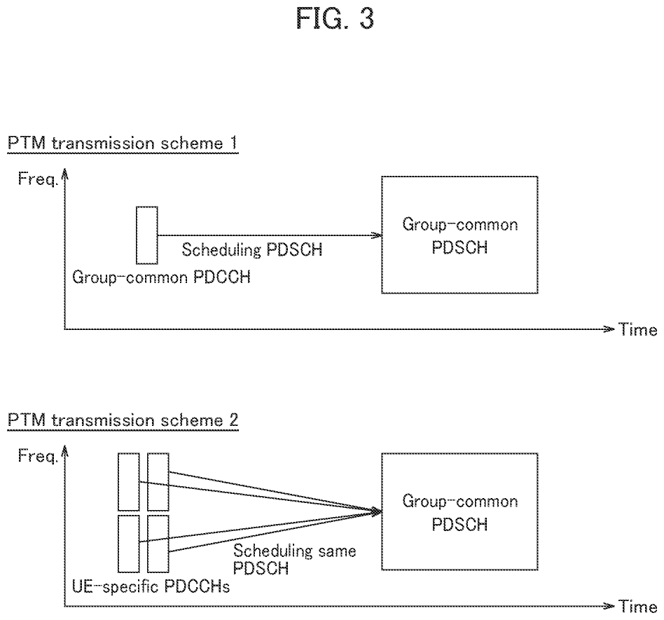

FIG. 3 shows configuration examples of PTM transmission method 1 and PTM transmission method 2. Note that the UE-specific PDCCH/PDSCH can be identified by the target UE but need not be identified by other UEs in the same MBS group. The group common PDCCH/PDSCH is transmitted in the same time/frequency resource and can be identified by all UEs in the same MBS group. In addition, the names of the PTM transmission methods 1 and 2 are tentative names and may be called by different names as long as the above operations are performed.

In point-to-point (PTP) delivery, the PAN node may deliver individual copies of the MBS data packets to individual UEs by radio. In point-to-multipoint (PTM) delivery, the PAN node may deliver a single copy of the MBS data packets to a set of UEs by radio.

In addition, in order to improve the reliability of MBS, the following two feedback methods are envisioned for HARQ (Hybrid Automatic repeat request) feedback, specifically, HARQ feedback for multicast/broadcast PDSCH.
Option 1: Feedback both ACK and NACK (ACK/NACK feedback)—The UE that successfully receives and decrypts the PDSCH sends an ACK—The UE that fails to receive and decrypt the PDSCH sends a NACK—PUCCH (Physical Uplink Control Channel) resource configurations: PUCCH-Config can be configured for multicasting
   PUCCH resources: Shared/orthogonal between UEs depends on network configurations
   HARQ-ACK CB (codebook): supports type-1 and type-2 (CB decision algorithm (specified in 3GPP TS 38.213)
   Multiplexing: Unicast or multicast can be applied
Option 2: NACK-only feedback
   A UE that successfully receives and decrypts a PDSCH does not send an ACK (does not send a response)
   A UE that fails to receive and decrypt a PDSCH sends a NACK
   For a given UE, PUCCH resource configurations can be set separately by unicasting or group casting (multicast)

Note that ACK may be referred to as positive acknowledgement and NACK as negative acknowledgement. HARQ may be called an automatic retransmitting request.

Enabling/Disabling Option 1 or Option 2 may be either:
RRC and Downlink Control Information (DCI)
RRC only

In addition, the following content is expected regarding SPS(Semi-persistent Scheduling) of multicast/broadcast PDSCH.
Adoption of SPS group-common PDSCH
Multiple SPS group-common PDSCH can be configured as UE capability
HARQ feedback available for SPS group-common PDSCH
At least activation/deactivation by group-common PDCCH

Note that deactivation may be replaced by other synonymous terms such as release. For example, activation may be replaced by start, start, trigger, etc., and deactivation may be further replaced by end, stop, etc.

SPS is scheduling used as a contrast to dynamic scheduling, which may be called semi-fixed, semi-persistent or semi-persistent scheduling, etc., and may be interpreted as Configured Scheduling(CS).

Scheduling may be interpreted as the process of allocating resources to transmit data. In dynamic scheduling, it may be interpreted as the mechanism by which all PDSCH are scheduled by the DCI (For example, DCI1_0, DCI1_1 or DCI1_2). SPS may be interpreted as the mechanism by which PDSCH transmission is scheduled by higher layer signaling, such as RRC messages.

In addition, with respect to the physical layer, there may be scheduling categories for time-domain scheduling and frequency-domain scheduling.

In addition, multicast, group-cast, broadcast, and MBS may be read in conjunction with each other. Multicast-PDSCH, PDSCH scrambled by group-common RNTI may be read in conjunction with each other.

Furthermore, the terms data and packets may be read in conjunction with each other and may be interpreted synonymously with terms such as signals, data units, etc.

In addition, transmission, reception, transmission and delivery may be read in conjunction with each other.

### (2) Function Block Configuration of Radio Communication System

Next, the functional block configuration of the radio communication system 10 will be described. Specifically, the functional block configuration of the gNB100 and the UE200 will be described.

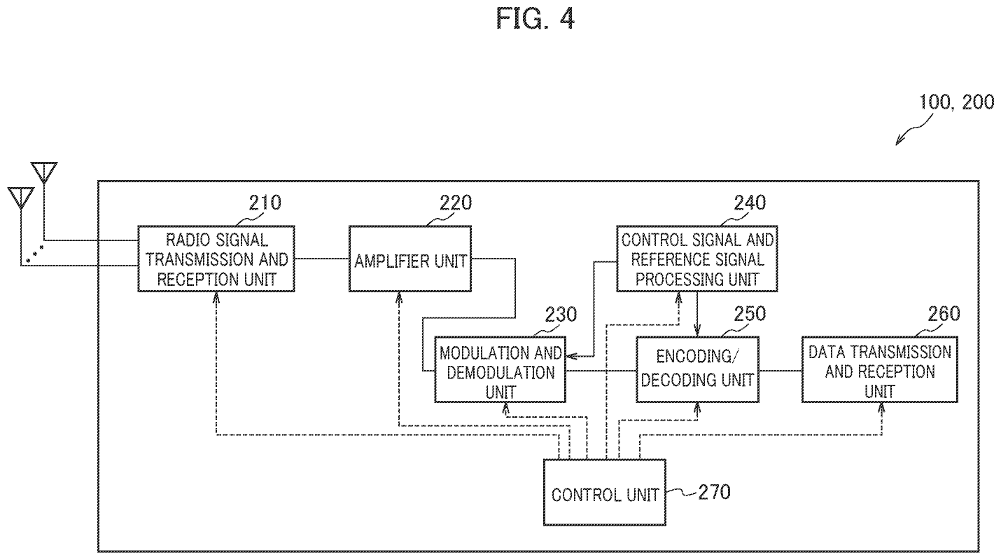

FIG. 4 shows the functional block configuration of the gNB100 and the UE200. The UE200 will be described below. As shown in FIG. 4, the UE200 includes a radio signal transmission and reception unit 210, an amplifier unit 220, a modulation and demodulation unit 230, a control signal and reference signal processing unit 240, an encoding/decoding unit 250, a data transmission and reception unit 260 and a control unit 270.

Note that only the main functional blocks related to the description of the embodiment are shown in FIG. 4, and the UE200 has other functional blocks (For example, the power supply). Also, FIG. 4 shows the functional block configuration of the UE200 (gNB100), and see FIG. 8 for the hardware configuration.

The radio signal transmission and reception unit 210 transmits and receives radio signals in accordance with NR. The radio signal transmission and reception unit 210 supports Massive MIMO, CA for bundling multiple CCs, and DC for simultaneously communicating between UE and each of the 2 NG-RAN nodes.

The radio signal transmission and reception unit 210 also supports MBS and can receive a downlink channel that is group common in data distribution for multiple UE200s. In this embodiment, the radio signal transmission and reception unit 210 may constitute a reception unit.

The radio signal transmission and reception unit 210 can receive a downlink data channel (PDSCH) common to a group of terminals, specifically, a group-common PDSCH (which may include an SPS group-common PDSCH). The radio signal transmission and reception unit 210 can also receive a downlink control channel common to a group of terminals, specifically, a group-common PDCCH.

The amplifier unit 220 is composed of a PA (Power Amplifier)/LNA (Low Noise Amplifier), etc. The amplifier unit 220 amplifies the signal output from the modulation and demodulation unit 230 to a predetermined power level. The amplifier unit 220 also amplifies the RF signal output from the radio signal transmission and reception unit 210.

The modulation and demodulation unit 230 performs data modulation/demodulation, transmission power setting and resource block allocation for each predetermined communication destination (such as the gNB 100). On modulation and demodulation unit 230, Cyclic Prefix-Orthologous Frequency Division Multiplexing (CP-OFDM)/Discrete Fourier Transform-Spread (DFT-S-OFDM) may be applied. DFT-S-OFDM may be used not only for the uplink (UL) but also for the downlink (DL).

The control signal and reference signal processing unit 240 performs processing for various control signals transmitted and received by the UE200 and processing for various reference signals transmitted and received by the UE200.

Specifically, the control signal and reference signal processing unit 240 receives various control signals transmitted from the gNB100 via a predetermined control channel, such as control signals of a radio resource control layer (RRC). The control signal and reference signal processing unit 240 also transmits various control signals to the gNB100 via a predetermined control channel.

The control signal and reference signal processing unit 240 performs processing using a reference signal (RS) such as a Demodulation Reference Signal (DMRS) and a Phase Tracking Reference Signal (PTRS).

DMRS is a known reference signal (pilot signal) between individual base stations and terminals for estimating a fading channel used for data demodulation. PTRS is a reference signal for individual terminals for estimating phase noise, which is a problem in high frequency bands.

In addition to DMRS and PTRS, the reference signal may include Channel State Information-Reference Signal (CSI-RS), Sounding Reference Signal (SRS), and Positioning Reference Signal (PRS) for location information.

In addition, the channel includes a control channel and a data channel. Control channels may include PDCCH, PUCCH (Physical Uplink Control Channel), RACH (Downlink Control Information (DCI) including Random Access Channel, Random Access Radio Network Temporary Identifier (RA-RNTI)), and Physical Broadcast Channel (PBCH).

Data channels may also include PDSCH, and PUSCH (Physical Uplink Shared Channel). Data may mean data transmitted through a data channel.

The encoding/decoding unit 250 performs data division/concatenation and channel coding/decoding, etc. for each predetermined communication destination (gNB100 or other gNB).

Specifically, the encoding/decoding unit 250 divides the data output from the data transmission and reception unit 260 into predetermined sizes and performs channel coding on the divided data. The encoding/decoding unit 250 also decodes the data output from the modulation and demodulation unit 230 and concatenates the decoded data.

The data transmission and reception unit 260 transmits and receives Protocol Data Units (PDU) and Service Data Units (SDU). Specifically, the data transmission and reception unit 260 performs assembly/disassembly of PDUs/SDUs in multiple layers (Media access control layer (MAC), radio link control layer (RLC), and packet data convergence protocol layer (PDCP), etc.). data transmission and reception unit 260 also performs error correction and retransmission control of data based on a hybrid automatic repeat request (ARQ).

The control unit 270 controls each functional block that constitutes the UE200. In particular, in the present embodiment, the control unit 270 performs control over the scheduling of the downlink channel with respect to the MBS and the HARQ feedback of the channel.

The control unit 270 performs control corresponding to the scheduling of the downlink channel that is common to a group of terminals in data distribution to the MBS, that is, multiple UEs 200. Specifically, the control unit 270 can perform control corresponding to the scheduling of the group-common PDCCH and the group-common PDSCH.

The control unit 270 may also assume that the process number (HARQ process ID) of the HARQ in the PDSCH (May include group-common PDSCH and SPS group-common PDSCH) for the downlink data channel, specifically the MBS, is different from the process number of the HARQ in the UE200 specific downlink channel (PDSCH).

The UE200 specific downlink channel (PDSCH) may be interpreted as a channel that is Unicast (PTP) transmitted (which may include retransmission) to a specific UE200 (or data transmitted via our unit downlink channel (transport block (TB)).

The HARQ process number (HPN) may be interpreted as a number that can identify HARQ processes that may be executed in multiple parallel, such as 0˜3. A control unit 270 may assume that the PDSCH's HPN for multicast/broadcast, such as group-common PDSCH, is different from the PDSCH's HPN for unicast-transmitted, i.e., that the same number is not assigned.

Note that the HPN for group-common PDSCH (related TB) may be set by parameters in the higher layer. The HPN for group-common PDSCH may be fixed, or once control unit 270 recognizes the HPN for group-common PDSCH, it may be assumed that the HPN is used for group-common PDSCH.

Also, when control unit 270 receives a Unicast Channel (TB) associated with an HPN that it has identified as being for the group-common PDSCH, it may assume that the TB is a retransmission associated with the group-common PDSCH.

The control unit 270 may assume that if the PDSCH for an MBS is retransmitted to a specific UE200, that is, retransmitted by PTP, the specific identification information (RNTI) for retransmission is used for scrambling the PDCCH (downlink control channel) and downlink channels such as the UE200 specific PDSCH.

Specifically, the control unit 270 may assume that if the group-common PDSCH transmitted by the PTM1 is retransmitted by PTP, the RNTI for scrambling the CRC of the PDCCH (which may include the DCI) and the RNTI for scrambling the PDSCH are predetermined RNTIs reserved for retransmission.

The control unit 270 may assume that a block (which may be read as data) transmitted over a downlink data channel such as the group-common PDSCH, specifically a transport block (TB), is retransmitted to only one of the multiple UEs 200 or a specific UE200. Specifically, control unit 270 may assume that the TB is retransmitted only with either PTM1 or PTP.

Note that whether the TB is retransmitted with PTM1 or PTP may be notified to the UE200 by signaling in the higher layer. In addition, whether retransmitting by PTM1 or PTP may be set for each HPN, and retransmitting by PTM1 or PTP may be set in association with the logical channel.

Alternatively, the control unit 270 may assume that a TB transmitted via a downlink data channel such as group-common PDSCH may be retransmitted for both multiple UEs 200 and a specific UE200.

Specifically, the control unit 270 may assume that group-common PDSCH may be retransmitted simultaneously by PTM1 and PTP.

A specific operation example for retransmitting TB transmitted via group-common PDSCH by PTM1 and PTP will be described later.

The gNB100 is also capable of performing the aforementioned control on downlink channel scheduling, retransmitting, and HARQ.

### (3) Operation of Radio Communication System

Next, the operation of radio communication system 10 will be described. Specifically, the operation related to the downlink channel scheduling with respect to the MBS and the channel with respect to HARQ feedback.

With respect to the MBS, the scheduling of HARQ retransmissions may be, but is not limited to, as shown in Table 1.

TABLE 1

HARQ feedback

| | | ACK/NACK | NACK-only |
|---|---|---|---|
| Initial TX | PTM-1 | PTM-1, PTP | PTM-1 |
| | PTM-2 | — | — |
| | PTP | — | — |

As shown in Table 1, if the initial transmission (Initial TX) of a TB is PTM-1 and the HARQ feedback is ACK and NACK(ACK/NACK), a retransmission for the HARQ of that TB may be performed by PTM-1 or PTP (both are acceptable).

On the other hand, if the initial TX of a TB is PTM-1 and the HARQ feedback is NACK-only, a retransmission for the HARQ of that TB may be performed by PTM-1.

Thus, a transport block (TB) transmitted by PTM-1 over the group-common PDSCH can be retransmitted by PTP, but for example, the handling of the HARQ process in this case may be a challenge. Furthermore, how the UE200 recognizes that it is a retransmission of a TB transmitted by PTM-1 may also be a challenge.

It is also necessary to consider whether it is possible to simultaneously perform retransmission by PTM-1 and retransmission by PTP for the retransmission of a TB transmitted by PTM-1. For example, in concurrent execution, retransmission by PTM-1 to a large number of UEs can save PDCCH and/or PDSCH resources. At the same time, retransmission by PTP to a specific (For example, one) UE (such as one located at the cell edge) can use the appropriate beam and MCS(Modulation and Coding Scheme). However, for a given TB, if a UE receives both retransmissions by the above PTM-1 and retransmissions by PTP, it is necessary to clarify which one is to be processed, for which HARQ feedback is to be given, etc.

In the following, we describe an example of an operation for retransmitting a TB transmitted via the group-common PDSCH that can solve this problem.

### (3.1) Operation Example 1

In this example of operation, the TB transmitted by the PTM-1 may be retransmitted by the PTP. In this example of operation, it may be that the HARQ process number (HPN, may be called HARQ process ID) pertaining to the group-common PDSCH transmitted by the PTM-1 must be a different value from other unicast transmissions.

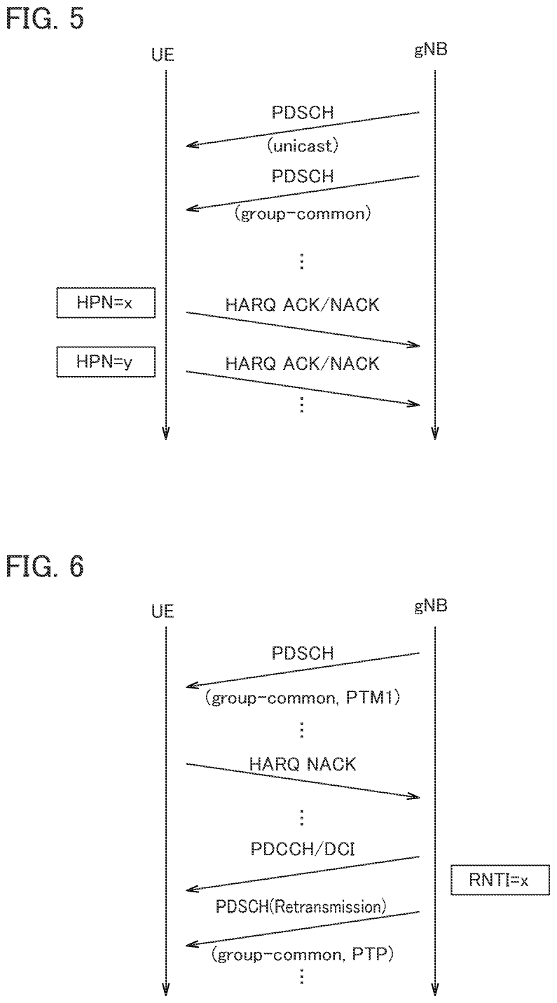

FIG. 5 shows a sequence example of the PDSCH and HARQ feedback pertaining to Example 1 of operation. As shown in FIG. 5, the HPN (For example, y) pertaining to the group-common PDSCH transmitted by the PTM-1 may have a different value from the HPN (For example, x) pertaining to the PDSCH of other unicast transmissions.

In this operation example, the higher layer (For example, RRC) NO parameter may set which HPN is for the TB associated with the group-common PDSCH.

The UE200 may assume that the HPN associated with the group-common PDSCH once received applies only to the TB transmitted via the group-common PDSCH.

Also, if the UE200 receives the Unicast data associated with the HPN associated with the group-common PDSCH (For example, if a DL assignment scrambled by C-RNTI is received), it may assume that the data is a TB retransmission via the group-common PDSCH.

### (3.2) Operation Example 2

Even in this example, the TB transmitted by the PTM-1 may be retransmitted by the PTP. In this example of operation, when the group-common PDSCH(TB) transmitted by the PTM-1 is retransmitted by the PTP, the RNTI for scrambling the CRC of the PDCCH (may be read as the DCI) and the RNTI for scrambling the PDSCH may be defined as a prescribed RNTI distinguished from other RNTIs.

FIG. 6 shows a sequence example of PDCCH, PDSCH and HARQ feedback relating to operation example 2. As shown in FIG. 6, the RNTI used for scrambling the CRC of the PDCCH/DCI and the RNTI used for scrambling the PDSCH(group-common PDSCH) to be retransmitted may be a prescribed RNTI (For example, x) distinguished from other RNTIs.

Such RNTI may be dedicated for retransmission by PTP. Alternatively, it may be another RNTI generated based on C (Cell)-RNTI or another RNTI generated based on G-RNTI. The other RNTI may be a value reversibly derived from C-RNTI/G-RNTI, for example, a value calculated by multiplying the value of C-RNTI/G-RNTI by a factor or the like.

### (3.3) Operation Example 3

In this example, the TB transmitted by PTM-1 is not retransmitted by both PTM-1 and PTP at the same time.

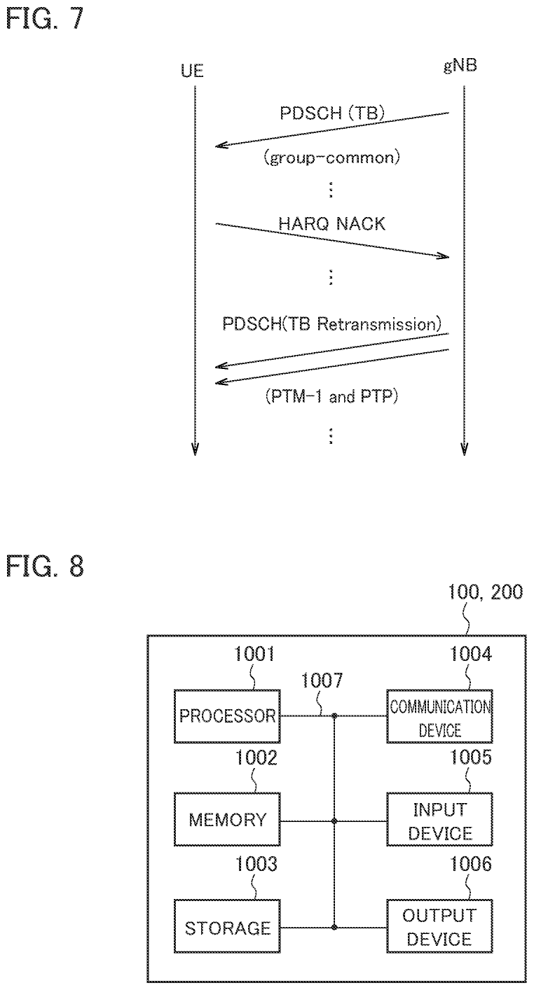

FIG. 7 shows a sequence example of PDSCH and HARQ feedback for operation example 3. In this operation example, for a TB transmitted via a certain group-common PDSCH, it may be assumed that the UE200 is retransmitted only by either PTM-1 or PTP. That is, the UE200 may not assume that the TB is retransmitted simultaneously by both PTM-1 and PTP.

Whether the TB is retransmitted by PTM1 or PTP may be set by the higher layer (For example, RRC). For example, the signaling of the RRC layer may inform the UE200 whether the TB is retransmitted by PTM1 or PTP. More specifically, the system information block (SIB) may inform the UE whether the TB is retransmitted by PTM1 or PTP, and a common configuration may be applied to all UEs in the cell.

In addition, whether the TB is retransmitted by PTM1 or PTP may be set for each HARQ process number (HPN), or retransmission by PTM1 or PTP may be set in association with a logical channel (LCH).

It may also be assumed that PDCCH/PDSCH reception and HARQ feedback transmission are in one set and that the UE200 does not transmit via another PDCCH/PDSCH of the same TB (via PTM-1 or PTP) from the start to the end of that one set.

In this case, the PDCCH/PDSCH included in the set may be limited to being transmitted via either PTM-1 or PTP. That is, it may be assumed that the UE200 does not receive the same TB via PTP between the receipt of that PDCCH/PDSCH by PTM-1 and the HARQ feedback. On the other hand, it may be assumed that the UE200 does not receive the same TB via PTM-1 between the receipt of that PDCCH/PDSCH by PTP and the HARQ feedback.

In addition, the UE200 may assume that PDCCH monitoring occurrence (MO))/search space/CORESET (control resource sets) causes PDCCH reception pertaining only to retransmissions by either PTM-1 or PTP.

### (3.4) Operation Example 4

Even in this example, the TB transmitted by the PTM-1 may be retransmitted simultaneously by both the PTM-1 and the PTP. In this working example, it may be assumed that for a TB transmitted over a certain group-common PDSCH, the UE200 can be retransmitted by both PTM-1 and PTP.

For the retransmission of a TB transmitted over a certain group-common PDSCH, a first PDCCH/PDSCH reception and a HARQ feedback transmission are set, and the UE200 may assume that transmission (a second PDCCH/PDSCH reception) over another PDCCH/PDSCH of the same TB (via PTM-1 or PTP) can occur from the start to the end of the set.

In this case, for example, the first PDCCH/PDSCH reception may be limited to being transmitted by either PTM-1 or PTP. In other words, it may be assumed that the UE200 may receive the same TB by PTP after receiving that PDCCH/PDSCH by PTM-1 and until the HARQ feedback, but not vice versa (Received by PTP, then same TB received by PTM-1).

Alternatively, it may be assumed that the UE200 may receive the same TB by PTM-1 after receiving that PDCCH/PDSCH by PTP and until the HARQ feedback, but not vice versa (Received by PTM-1, then same TB received by PTP).

It may also be assumed that in a given PDCCH monitoring occurrence (MO)/search space/CORESET, the UE200 receives PDCCH pertaining to retransmission by both PTM-1 and PTP.

In retransmissions by both PTM-1 and PTP, radio resources that are at least partially the same (In other words, duplicated), specifically time resources or frequency resources, may be used.

In retransmissions by both PTM-1 and PTP described above, when the UE200 receives a PDCCH for retransmissions by PTM-1 and a PDCCH for retransmissions by PTP, it may perform prescribed processing for reception and/or decoding. Specifically, the following processing may be performed.
Perform receive/decrypt processing only for retransmissions by PTM-1
Perform receive/decrypt processing only for retransmissions by PTP
Perform receive/decrypt processing only for PDCCH/PDSCH received earlier in time
Perform receive/decrypt processing for retransmissions by both PTM-1 and PTP

In this case, the UE200 may synthesize and decode signals retransmitted by both PTM-1 and PTP.

In addition, in retransmitting by both PTM-1 and PTP described above, the UE200 may perform prescribed processing related to HARQ feedback when receiving a PDCCH related to retransmitting by PTM-1 and a PDCCH related to retransmitting by PTP. Specifically, the following processing may be performed.
For HARQ processes related to retransmissions for which no receive/decrypt processing was performed, feedback is provided as a predetermined response (For example, NACK).
For HARQ processes related to retransmissions for which no receive/decrypt processing was performed, no feedback is provided.
For each retransmission for which receive/decrypt processing was performed for both PTM-1 and PTP, feedback is provided.

In this case, the information to be fed back may be the same or different.
The content of the feedback may be multiplexed if the time domain (For example, slot) in which the feedback for retransmission by PTM-1 and PTP is performed is the same, or if at least some of the resources for the feedback overlap.

### (3.5) Variations

The above example of operation 1˜4 may be applied in combination as long as there is no conflict. In addition, as described above, the term indicating a time region such as a slot may be replaced by the term indicating another time region such as a subslot.

Although the operation example described above was related to an MBS for simultaneous transmission (delivery) to multiple UEs, the UEs subject to an MBS need not always be multiple, and if an operation according to the MBS is performed, such as using a group-common PDSCH, the specific or unspecified multiple UEs may or may not be substantially one.

### (4) Operational Effects

According to the above embodiment, the following operation effects can be obtained. Specifically, according to the UE200 pertaining to the operation example 1˜4, data (TB) to be transmitted and retransmitted by the PTM-1 and/or the PTP can be reliably received and appropriate HARQ feedback can be executed. That is, according to the UE200, data to be retransmitted can be more reliably received in a simultaneous data transmission service (MBS) to multiple specified or unspecified UEs 200.

In this embodiment, the UE200 may assume that the HPN of the PDSCH for the MBS is different from the HPN in the UE200 specific downlink channel (PDSCH). Thus, the UE200 can easily and reliably recognize, based on the HPN, that it is a TB retransmission via the PDSCH for the MBS.

In this embodiment, the UE200 may assume that if the group-common PDSCH transmitted by the PTM1 is retransmitted by the PTP, the RNTI scrambling the CRC of the PDCCH (which may include the DCI) and the RNTI scrambling the PDSCH are predetermined RNTIs reserved for retransmission. Thus, the UE200 can easily and reliably recognize the retransmitted TB.

In this embodiment, the UE200 may assume that a TB transmitted via a downlink data channel such as group-common PDSCH is retransmitted to only one of the multiple UEs 200 or a specific UE200. Alternatively, the UE200 may assume that TBs transmitted over a downlink data channel, such as group-common PDSCH, will be retransmitted to both multiple UEs 200 and a specific UE200. Thus, the UE200 can easily and reliably recognize the retransmitted TBs.

### (5) Other Embodiments

Although the above description of the embodiment is not limited to the description of the said embodiment, it is obvious to those skilled in the art that various modifications and improvements are possible.

For example, in the above described embodiment, the names PDCCH and PDSCH were used as the downlink channels, but if it is a downlink control channel or downlink data channel (which may be a shared channel), it may be called by another name.

Also, in the above description, the words configure, activate, update, indicate, enable, specify, and select may be replaced with each other. Similarly, link, associate, correspond, map may be replaced with each other, and allocate, assign, monitor, and map may be replaced with each other.

In addition, specific, dedicated, UE-specific, and UE-specific may be interchanged. Similarly, common, shared, group-common, UE-common, and UE-shared may be interchanged.

In addition, the block diagram (FIG. 4) used for the description of the above described embodiment shows blocks of functional units. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, the functional block (component) that makes transmission work is called a transmitting unit (transmission unit) or transmitter. In either case, as described above, the implementation method is not particularly limited.

Furthermore, the gNB100 and the UE200 described above may function as computers performing processing of the radio communication method of this disclosure. FIG. 8 is a diagram showing an example of the hardware configuration of the device. As shown in FIG. 8, the device may be configured as a computer device including a processor 1001, a memory 1002, a storage 1003, an communication device 1004, an input device 1005, an output device 1006, a bus 1007, etc.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIG. 4) is realized by any hardware element of the computer device or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001 controls the entire computer by, for example, operating the operating system. The processor 1001 may consist of a central processing unit (CPU) including interfaces with peripheral devices, controllers, arithmetic units, registers, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. Memory 1002 may be referred to as a register, cache, main memory, etc. Memory 1002 may store programs (program code), software modules, etc., that are capable of executing a method according to one embodiment of this disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device such as a processor 1001 and a memory 1002 is connected by a bus 1007 for communicating information. The bus 1007 may be configured using a single bus or different buses for each device.

Further, the device is configured to include hardware such as a microprocessor, a digital signal processor (Digital Signal Processor: DSP), Application Specific Integrated Circuit (ASIC), Programmable Logic Device (PLD), and Field Programmable Gate Array (FPGA). Some or all of these functional blocks may be realized by the hardware. For example, the processor 1001 may be implemented by using at least one of these hardware.

Also, the notification of information is not limited to the mode/embodiment described in this disclosure and may be made using other methods. For example, the notification of information may be carried out by physical layer signaling (e.g., Downlink Control Information (DCI), Uplink Control Information (UCI), higher layer signaling (e.g., RRC signaling, Medium Access Control (MAC) signaling, notification information (Master Information Block (MIB), System Information Block (SIB)), other signals or a combination thereof. The RRC signaling may also be referred to as an RRC message, e.g., an RRC Connection Setup message, an RRC Connection Reconfiguration message, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, etc., of each mode/embodiment described in this disclosure may be reordered as long as there is no conflict. For example, the method described in this disclosure uses an illustrative order to present elements of various steps and is not limited to the specific order presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from a higher layer (or lower layer) to a lower layer (or higher layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each aspect/embodiment described in this disclosure may be used alone, in combination, or switched over as practice progresses. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channels and symbols may be a signal (signaling). Also, the signal may be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile body may be a vehicle (For example, cars, airplanes, etc.), an unmanned mobile body (For example, drones, self-driving cars, etc.) or a robot (manned or unmanned). At least one of a base station and a mobile station can be a device that does not necessarily move during the communication operation. For example, at least one of a base station and a mobile station may be an Internet of Things (IoT) device such as a sensor.

The base station in this disclosure may also be read as a mobile station (user terminal, hereinafter the same). For example, each mode/embodiment of this disclosure may be applied to a configuration in which communication between a base station and a mobile station is replaced with communication between multiple mobile stations (For example, it may be called Device-to-Device (D2D), Vehicle-to-Everything (V2X), etc.). In this case, the mobile station may have the function of the base station. In addition, words such as “up” and “down” may be replaced with words corresponding to communication between terminals (For example, “side”). For example, an up channel or a down channel may be replaced with a side channel (or a side link).

Similarly, a mobile station in this disclosure may be replaced with a base station. In this case, the base station may have the function of the mobile station. A radio frame may be composed of one or more frames in the time domain. Each frame or frames in the time domain may be referred to as a subframe. A subframe may be further configured by one or more slots in the time domain. A subframe may have a fixed length of time (For example, 1 ms) independent of numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. A PDSCH (or PUSCH) transmitted in units of time larger than a minislot may be referred to as a PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the subframes and TTI may be a subframe (1 ms) in an existing LTE, may have a duration shorter than 1 ms (For example, 1-13 symbols), or may have a duration longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When a TTI is given, the time interval (For example, the number of symbols) to which the transport block lock, code word, etc. are actually mapped may be shorter than the TTI.

When one slot or one minislot is called TTI, one or more TTIs (that is, one or more slots or one or more minislots) may be the minimum scheduling unit. In addition, the number of slots (number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be identified by an index of RBs relative to the common reference point of the carrier. PRB may be defined in BWP and numbered within that BWP.

BWP may include UL BWP (UL BWP) and DL BWP (DL BWP). One or a plurality of BWPs may be configured in one carrier for the UE.

At least one of the configured BWPs may be active, and the UE may not expect to send and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected,” “coupled,” or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to an element using a designation such as “first,” “second,” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include,” “including,” and variants thereof are intended to be inclusive in a manner similar to the term “comprising.” Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. That is, “judgment” and “determination” may include regarding some action as “judgment” and “determination.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
20 NG-RAN
100 gNB
200 UE
210 radio signal transmission and reception unit
220 amplifier unit
230 modulation and demodulation unit
240 control signal and reference signal processing unit
250 encoding/decoding unit
260 data transmission and reception unit
270 control unit
1001 processor
1002 memory
1003 storage
1004 communication device
1005 input device
1006 output device
1007 Bus

1. A terminal comprising:
a reception unit that receives a downlink data channel common to a group of terminals in data distribution for multiple terminals; and
a control unit that assumes that a process number of an automatic retransmission request in the downlink data channel is different from a process number of an automatic retransmission request in a terminal-specific downlink channel.

2. A terminal comprising:
a reception unit that receives a downlink data channel common to a group of terminals in data distribution for multiple terminals; and
a control unit that assumes that specific identification information for retransmission is used for scrambling a downlink control channel and a terminal-specific downlink channel when the downlink data channel is retransmitted to a specific terminal.

3. A terminal comprising:
a reception unit that receives a downlink data channel common to a group of terminals in data distribution for multiple terminals; and
a control unit that assumes that a block transmitted via the downlink data channel is retransmitted to only one of the terminals or a specific terminal.

4. A terminal comprising:
a reception unit that receives a downlink data channel common to a group of terminals in data distribution for multiple terminals; and
a control unit that assumes that a block transmitted via the downlink data channel can be retransmitted to both the terminals and a specific terminal.

5. A radio communication method comprising the steps of:
receiving a downlink data channel common to a group of terminals in data distribution for multiple terminals; and
assuming that a process number of an automatic retransmission request in the downlink data channel is different from a process number of an automatic retransmission request in a terminal-specific downlink channel.

6. A radio communication method comprising the steps of:
receiving a downlink data channel common to a group of terminals in data distribution for multiple terminals; and
assuming that specific identification information for retransmission is used for scrambling a downlink control channel and a terminal-specific downlink channel when the downlink data channel is retransmitted to a specific terminal.
